(19) United States
(12) Patent Application Publication
(10) Pub. No.: US 2002/0074501 A1
(43) Pub. Date: Jun. 20, 2002

(54) Measurement of radiation dose and production of radiation image

(76) Inventors: Yuji Isoda, Kanagawa (JP); Yasuo Iwabuchi, Kanagawa (JP)

Correspondence Address: SUGHRUE, MION, ZINN, MACPEAK & SEAS, PLLC, 2100 PENNSYLVANIA AVENUE, N.W., WASHINGTON, DC, 20037-3202, US

(21) Appl. No.: 09/773,770

(22) Filed: Feb. 2, 2001

(30) Foreign Application Priority Data
Feb. 2, 2000 (JP) 2000-025569

(51) Int. Cl. G01T 1/20

(52) U.S. Cl. 250/363.01

(57) ABSTRACT

A green light emitting from a terbium-samarium co-activated alkaline earth metal rare earth oxide phosphor which is composed of an oxygen atom and a composition of the formula:

M^{II}M^{III}₂:xTb,ySm

[M^{II} is Mg, Ca, Sr or Ba; M^{III} is Y, La, Gd or Liu; 0<x≦0.1; and 0<y≦0.1] upon irradiating a radiation or ultraviolet rays can be favorably employed for measuring the radiation or ultraviolet rays. The green light, if desired, in combination with a red light emitting the phosphor, is also employable for producing a radiation image.

### FIELD OF THE INVENTION

The present invention relates to measurements of a radiation dose or a dose of ultraviolet rays using a terbium-samarium co-activated rare earth activated alkaline earth metal rare earth oxide phosphor. The invention further relates to new uses of the phosphor.

### BACKGROUND OF THE INVENTION

A phosphor emits a light by applying radiation such as UV light, electron beams, or X-rays, or by application of electric fields. various phosphors have been hitherto studied and practically used for various purposes such as illumination (luminescent lamps), image displaying, and radiation measurement. Display devises comprising phosphors are also known, for instance, CRT and VFD. Also known is a radiation image storage panel (i.e., stimulable phosphor sheet) containing a stimulable phosphor. The radiation image storage panel is favorably employed for a radiation image recording and reproducing method.

U.S. Pat. No. 5,391,884 discloses a phosphor and an X-ray imaging plate comprising the phosphor. The disclosed phosphor contains an activated gadolinate host, and the host is essentially composed of oxygen atom and the complex composition having the following formula:

BaGd₂:yTb,zSm

[wherein, y and z are numbers satisfying the conditions of 0<y<1, 0<z<5, and 1×10⁻⁵<y+z<6.0].

The above-mentioned phosphor absorbs X-rays, and emits light in a longer wavelength region. Further, if the phosphor having been exposed to the X rays is stimulated with light in the wavelength region of 600 to 1,200 nm, it emits a light (i.e., stimulated emission) having an intensity stronger than that given by the phosphor without Tb and Sm. Accordingly, U.S. Pat. No. 5,341,884 indicates that the disclosed phosphor gives stimulated emission advantageously employable for an X-ray imaging plate.

The co-pending U.S. Ser. No. 09/456,499 teaches at when the terbium-samarium co-activated alkaline earth metal rare earth oxide phosphor is excited with a radiation (e.g., UV light X-ray), it emits luminescence comprising both green component (which is thought to originate from Tb³⁺) and red one (which is thought to originate from Sm³⁺) Each luminescent component has a different response time to the excitation, and the ratio between them depends on the alkaline earth metal and the rare earth (which are the center metal atoms in the phosphor matrix). Therefore, the time difference between these luminescent components can be controlled by selecting the center metal atoms in the phosphor matrix.

### SUMMARY OF THE INVENTION

The present inventors have made further studies on the terbium-samarium co-activated alkaline earth metal rare earth oxide phosphor and found out a number of interesting and industrially utilizable characteristics of the phosphor.

Accordingly, it is an object of the present invention to provide new uses of the terbium-samarium co-activated alkaline earth metal rare earth oxide phosphor.

Specifically, the invention resides in a method for measuring a radiation dose which comprises the steps of:

applying a target radiation to a dosimeter containing a terbium-samarium co-activated alkaline earth metal rare earth oxide phosphor which is composed of an oxygen atom and a composition of the formula (I):

M^{II}M^{III}₂:xTb,ySm

in which M^{II} is at least one alkaline earth metal element selected from the group consisting of Mg, Ca, Sr and Ba; M^{III} is at least one rare earth element selected from the group consisting of Y, La, Gd and Lu; and x and y are numbers satisfying the conditions of 0<x≦0.1 and 0<y≦0.1, respectively; and

measuring a variation per unit time of strength of a green light emitted by the phosphor.

The invention also resides in a method of producing a radiation Page which comprises the steps of:

applying a radiation having passed through a target or having been radiated by a target onto a radiation image storage panel containing a layer of the above-identified terbium-samarium co-activated alkaline earth metal rare earth oxide phosphor;

determining a variation per unit time of strength of a green light emitted by the phosphor in each pixel which is imaginarily set on the storage panel, to obtain two-dimensional image data for each pixel; and

producing a radiation image from the obtained image data.

The invention further resides in a method for measuring a dose of ultraviolet rays which comprises the steps of:

applying a target radiation to a means containing the above-identified terbium-samarium co-activated alkaline earth metal rare earth oxide phosphor; and

measuring a variation per unit time of strength of a green light emitted by the phosphor.

The invention furthermore resides in a method for measuring a radiation dose which comprises the steps of:

applying ultraviolet rays to a dosimeter containing; the aforementioned terbium-samarium co-activated alkaline earth metal rare earth oxide phosphor;

measuring a strength of a green light and a strength of a red light emitted by the phosphor to which the ultraviolet rays have been applied;

applying a target radiation to the dosimeter, so as to cause variation of atomic valency for the terbium and samarium;

applying ultraviolet rays to the dosimeter to which the target radiation has been applied;

measuring a strength of green light and a strength of a red light emitted by the phosphor to which the ultraviolet rays have been applied after application of the target radiation; and

comparing the former strengths of the green light and red light with the latter strengths of the green light and red light.

The invention furthermore resides in a method of producing a radiation image which comprises the steps of:

applying ultraviolet rays to a radiation image storage panel containing a layer of the aforementioned terbium-samarium co-activated alkaline earth metal rare earth oxide phosphor;

measuring in each pixel which is imaginarily set on the storage panel, a strength of a green light and a strength of a red light emitted by the phosphor to which the ultraviolet rays have been applied, to obtain two-dimensional image data for each pixel;

applying a radiation having passed through a target or having been radiated by a target onto a radiation image storage panel, so as to cause variation of atomic valency for the terbium and samarium in each pixel;

applying ultraviolet rays to the storage panel to which the target radiation has been applied;

determining in each pixel a strength of green light: and a strength of a red light emitted by the phosphor to which the ultraviolet rays have been applied after application of the target radiation, to obtain two-dimensional image data for each pixel; and

processing the latter strengths of the green light and red light with reference to the former strengths of the green light and red light in each pixel, for producing a radiation image from the obtained image data.

Tn the invention, examples of the radiations include X-rays, ionizing radiations such as γ-rays, β-rays and α-rays, and neutron rays. The ultraviolet rays are light having a wavelength region of 250 nm to 400 nm.

### BRIEF DESCRIPTION OF DRAWINGS

FIG. 1 shows an emission spectrum of BaGd₂O₄:0.002Tb,0.0002Sm phosphor excited with X-rays.

FIG. 2 shows time-dependency of the emission intensity of BaGd₂O₄:0.002Tb,0.0002Sm phosphor excited with X-rays in which the solid line 1 is for a green light and the dotted line 2 is for a red light.

FIG. 3 shows a model of time-dependency of emission intensity of a green light emitting from the terbium-samarium co-activated alkaline earth metal rare earth oxide phosphor of the invention.

FIG. 4 shows a model of time-dependency of emission intensity of a green light emitted by the known terbium-activated alkaline earth metal rare earth oxide phosphor.

FIG. 5 shows a schematic view of a typical dosimeter of the invention.

FIG. 6 graphically shows a curve (i.e., calibration curve) indicating a relationship between a radiation dose of X-rays and a variation of fluorescence strength per sec.

FIG. 7 graphically shows a ce (i.e., calibration curve) indicating a relationship between a dose of ultra-violet rays and a variation of fluorescence strength per sec.

FIG. 8 shows at (1) a schematic view of a typical radiation image storage panel employed in the invention dosimeter of the invention, and at (2) an enlarged section of the storage panel taken along the line I-I.

FIG. 9 graphically shows a curve (i.e., calibration curve) indicating a relationship between a radiation dose of X-rays and a variation of fluorescence strength (F).

### DETAILED DESCRIPTION OF THE INVENTION

A process for preparing a terbium-samarium co-activated alkaline earth metal rare earth oxide phosphor of the invention is described below.

In the first places an alkaline earth metal oxide and a rare earth oxide (which form in combination a precursor of the phosphor matrix) and terbium oxide and samarium oxide (which are oxides of the activator) are pulverized and mechanically stirred for mixing. The obtained mixture is placed in a heat-resistance container such as an alumina crucible, a quartz boat or crucible, and then fired in an electric furnace. A preferred temperature for the firing is in the range of 1,100 to 1,300° C., and more preferably is approx. 1,200° C. As the firing atmosphere, a nitrogen gas atmosphere is preferred. The firing period is determined upon various conditions such as the amount of the mixture placed in the container, the firing temperature, and the temperature at which the product is taken out of the furnace. It generally is in the range of 1 to 5 hours, preferably 2 to 4 hours.

After the firing, the temperature in the furnace is lowered and then the fired product is taken out. The product can be further subjected to various known treatments such as pulverizing and sieving, if needed.

The above-described preparation process gives a terbium-samarium co-activated alkaline earth metal rare earth oxide phosphor comprising oxygen atom and the composition represented by the formula (I):

M^{II}M^{III}₂:xTb,ySm (I)

[wherein, M^{II} is at least one alkaline earth metal element selected from the group consisting of Mg, Ca, Sr and Ba; M^{III} is at least one rare earth element selected from the group consisting of Y, La, Gd and Lu; and x and y are numbers satisfying the conditions of 0<x≦0.1 and 0<y≦0.1, respectively].

Preferably, M^{II} is Sr and/or Ba. M^{III} also preferably is Y and/or Gd. Further, x and y preferably satisfy the conditions of 0.0001≦x≦0.01 and 0.00001≦y≦0.001, respectively.

The emission property of the phosphor of the invention is described below by referring to the attached drawings.

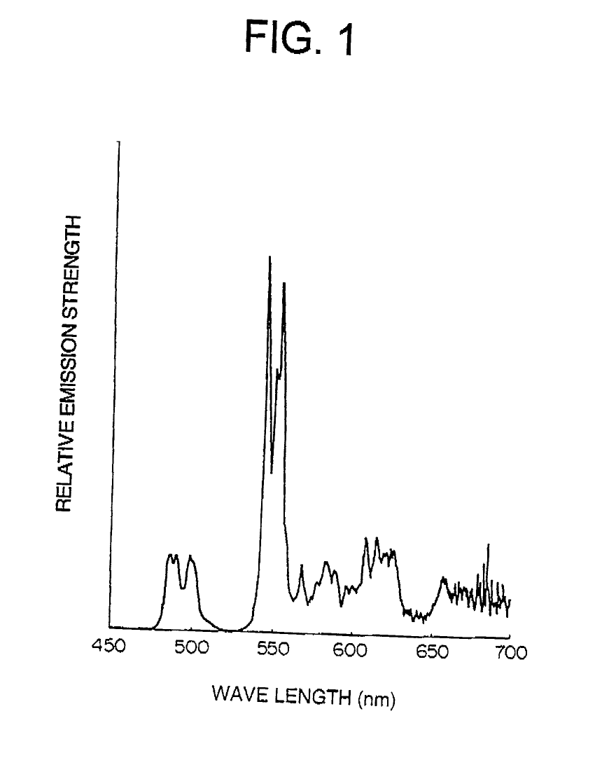

FIG. 1 shows an emission spectrum of the phosphor of BaGd₂O₄:0.002Tb,0.0002Sm (an example of the phosphor of the invention) excited with X-rays.

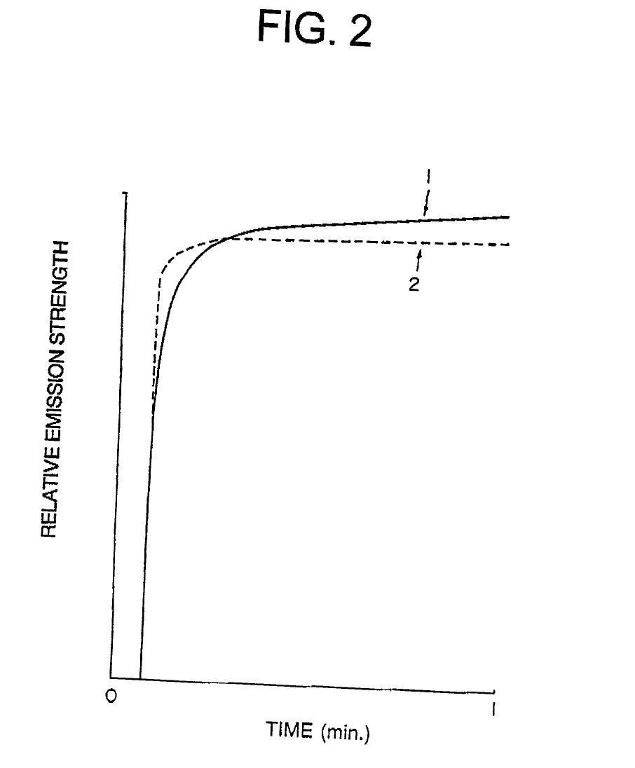

FIG. 2 shows time-dependency of the emission intensity of BaGd₂O₄:0.002Tb,0.0002Sm phosphor excited with X-rays. In FIG. 2, the solid line 1 and the dotted line 2 represent green and red luminescent components, respectively.

Even if the Ba is replaced with other alkaline earth metals such as Ca, Mg, or Sr, almost the same spectrum is obtained. Further, even if the Gd is replaced with other rare earth metals such as Y, La or Lu, almost the same spectrum is obtained.

As is shown in FIG. 1, the phosphor of the invention. gives a luminescence comprising green component (approx. at 550 nm) and red one (approx. at 610 nm). The luminescence centers of de green and red components are considered to be Tb³⁺ and Sm³⁺, respectively.

FIG. 2 further shows that BaGd₂O₄:0.002Tb,0.0002Sm phosphor emits the green luminescent component later than it emits the red one by approx. 0.5 second. In other words, the green component (originating from Tb³⁺) exhibits a response to the excitation slower than the red one (originating from Sn³⁺). Under observation with the human eyes, the red light can be seen immediately after the excitation, and then the green light can be seen approx. 0.5 second later. The ratio between the green and red components varies according to the center metal atoms in the matrix (even if the activators are the same). Accordingly, the time difference between these luminescent components can be controlled by optimizing the conditions of the phosphor matrix (e.g., by selecting the center metal atoms and/or by adjusting the ratio thereof). Further, in the case where the phosphor is excited with ultraviolet rays, the excitation maximums for the green and red components are approx. 315 nm and approx. 408 nm, respectively. Accordingly, it is possible to selectively excite the phosphor so that the green or red component can be predominantly obtained.

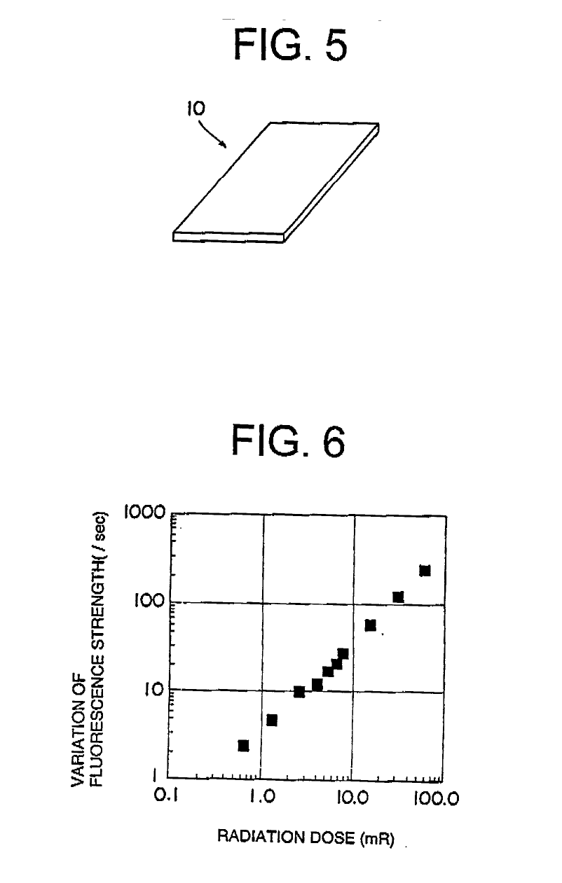

The terbium-samarium co-activated alkaline earth metal rare earth oxide phosphor of the invention is preferably employed in the form of a sheet containing the phosphor. See a sheet 10 of FIG. 5. The sheet may contain a binder polymer which binds the phosphor in the form of particles. The sheet generally is in a rectangular shape having a size of 1 to 100 cm×1 to 100 cm, and a thickness of 1 to 1,000 μm.

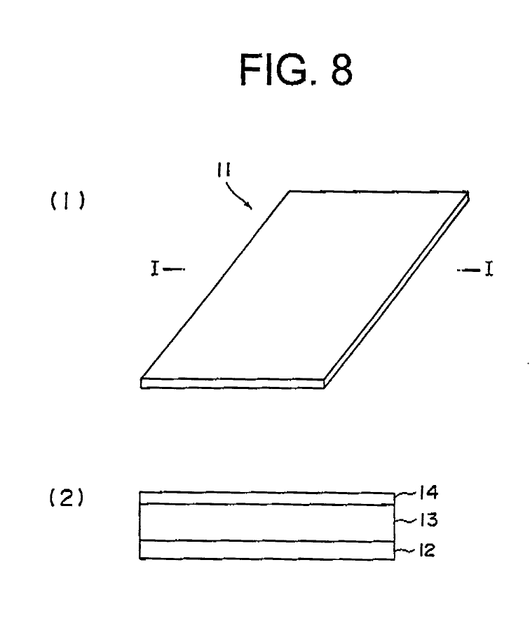

Otherwise, as is illustrated in FIG. 8, the phosphor is preferably employed in the form of a radiation image storage panel 11 comprising a support sheet 12 and a layer 13 of the phosphor. The layer of the phosphor preferably comprises phosphor particles and a binder polymer. On the phosphor layer 13, a protective layer 14 may be placed. Possible structures and possible variations of the radiation image storage panel (i.e., stimulable phosphor sheet) are known and are applicable to the preparation of the radiation image storage panel containing the phosphor of the invention.

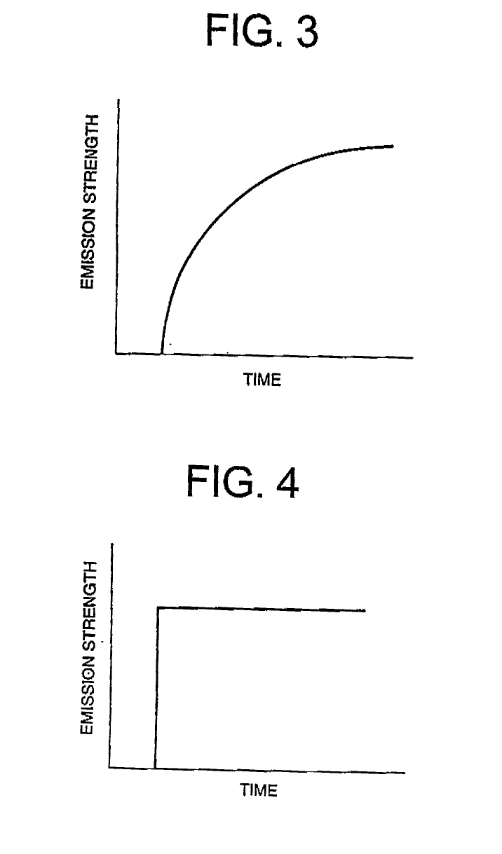

The terbium-samarium co-activated alkaline earth metal rare earth oxide phosphor emits a green light and a red light when it is irradiated with X-rays. A typical time-dependency of the green light is schematically illustrated in FIG. 3. For comparison, a typical time-dependency of a green light emitting from the known terbium activated alkaline earth metal rare earth oxide phosphor is illustrated in FIG. 4.

As is apparent from comparison of FIG. 3 and FIG. 4, the green light emitting from the Th/Sm co-activated phosphor of the invention shows a variation of fluorescence strength which is not sharp, as compared with the variation of the fluorescence strength of the green light of the Tb-activated phosphor.

It has been now found by the inventors that there is a specific relationship (such as linear relationship) between the radiation dose of X-rays and the ratio of increase of the fluorescence strength of green light within a certain time range. The relationship is illustrated in FIG. 6.

Accordingly, if a calibration curve is prepared by applying a standard target radiation in a predetermined dose to the phosphor and measuring a variation per unit time (such as one second after excitation) of strength of a green light emitted by the phosphor, unknown radiation dose can be determined by repeating the same procedure and comparing the measured variation value with the calibration curve. Thus, the phosphor of the invention can be employed as a dosimeter.

For instance, X-rays radiated by an X-ray tube (W-40 kVp) are applied to a dosimeter sheet containing a phosphor of SaGd₂O₄:0.0001Tb,0.0003Sm to give a radiation dose of 1 to 100 mR, and a fluorescence emitting from the phosphor within one second is detected at a wavelength of 555 nm (green light, slit: 5 nm).

The above-mentioned phenomenon of the phosphor of the invention can be utilized for production of a radiation image if the green light is detected from each pixel imaginarily formed on a sheet such as a radiation image storage panel using a light-collecting means such as CC) and the detected green light is converted into a digital. data. The digital data are collected from each pixel and processed to produce a two-dimensionally extended radiation image in the manners utilized in the know radiation image recording and reproducing method.

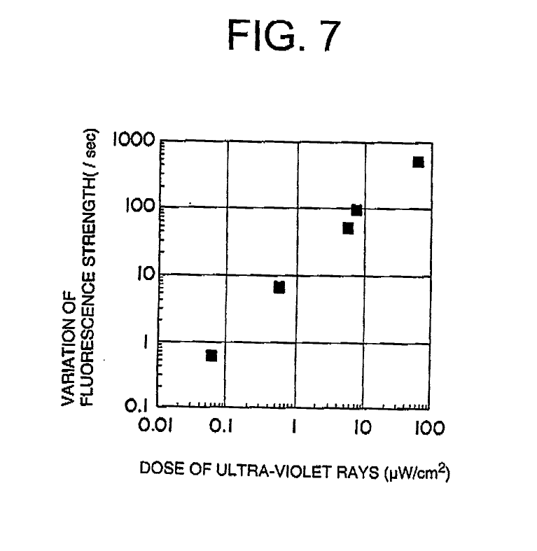

The phosphor of the invention further shows that the green light is also emitted when the phosphor is irradiated with ultraviolet rays. The green light emitting after irradiation of ultraviolet rays shows a relationship between the dose of ultraviolet rays and the ratio of increase of the fluorescence strength of green light in a certain time range, as is illustrated in FIG. 7.

For instance, ultraviolet rays having a wavelength 315 nm (or 240 nm) are applied to a sheet containing a phosphor of BaGd₂O₄:0.0001Th,0.0003Sm to give a UV dose of 0.01 to 100 μW/cm², and a fluorescence emitting within one second is detected at a wavelength of 555 nm (green light, slit: 5 nm).

It is further discovered by the present inventors that the terbium (Tb3⁺) and samarium (Sn³⁺) each of which forms an emission center of the phosphor of the invention to emit a green light and a red light, respectively, show variations of their atomic valencies when irradiated with radiations such as X-rays, that thus irradiated phosphor shows variation of the fluorescence strength for each of green light and red light, and that there is a relationship (such as a linear relationship) of the variation of fluorescence strength between the green light and red light.

Accordingly, the phosphor of the invention can be employed as a dosimeter for measuring a radiation dose utilizing the above-mentioned relationship. A typical procedure is described below.

A sheet containing the phosphor is irradiated with ultraviolet rays, and a fluorescence strength of green light emitting from terbium, Io(Th) and a fluorescence strength of red light emitting from samarium, Io(Sm), are measured. The excitation wavelength for terbium is approx. 315 nm, while that for samarium is approx. 408 nm. If the excitation wavelength of 315 nm is utilized, both of terbium and samarium are excited.

Subsequently, a target radiation (i.e., radiation to be measured in its radiation dose) is applied to the sheet having been irradiated with the ultraviolet rays. By the application of radiation such as X-rays, both of terbium and samarium vary in their atomic valencies.

Thereafter, the sheet is again subjected to irradiation of ultraviolet rays, to measure a strength of green fluorescence, I(Tb), and a strength of red fluorescence I(Sm). The atomic valencies of Tb and Sm vary differently by the application of radiation, and the fluorescence strength varies in each of the green light and the red light.

From the fluorescence strengths obtained in the above-mentioned procedure, the variation of strength, namely, F[Io(Tb),Io(Sm),I(Tb),I(Sm)] can be calculated according to one of the following equations (i) and (ii):

F=[I(Tb)/I(Sm)]/[Io(Tb)/Io(Sm)] (i)

F=[I(Tb)−Io(Tb)]/I(Sm) (ii)

Accordingly, a calibration curve representing the relationship between the radiation dose and the variation of fluorescence (F) can be prepared. The variation of the atomic valencies of terbium and samarium is returned back to the original state after the emission of fluorescence by the irradiation of ultraviolet rays.

In more detail, the procedure can be performed in the following manner.

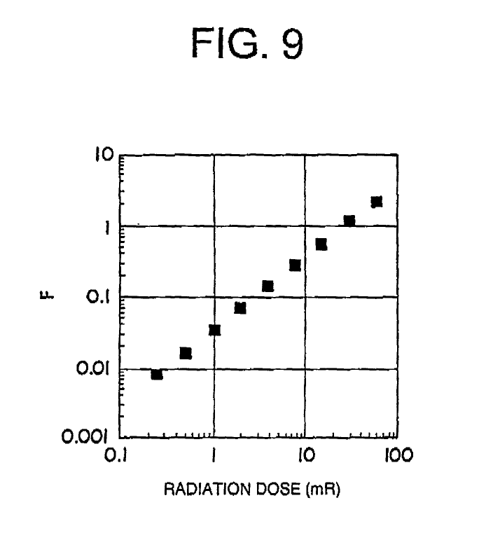

A sheet containing BaGd₂O₄:0.0001Tb,0.0003Sm phosphor (i.e., dosimeter) is irradiated with ultraviolet rays (wavelength: 315 nm, dose; 0.8 μW/cm²), and each of strengths of fluorescences [Io(Th), Io(Sm)] are measured at 555 nm (for green fluorescence, slit: 5 nm) and at 61.0 nm (for red fluorescence, slit: 5 nm). The sheet is then subjected to X-ray irradiation (tube voltage W-40 kVP). Subsequently, the sheet is again irradiated with the sane ultraviolet rays to measure each of strengths of fluorescences [I(Th), I(Sm)]. The measured strengths of fluorescences are incorporated into the aforementioned equation (i) to give the variation of fluorescence strength (F). By varying the radiation dose of X-rays in the range of 0.1 to 100 mR, the variation of fluorescence strength (F) illustrated in FIG. 9 is obtained.

FIG. 9 is a calibration curve representing the relationship between the radiation dose of X-rays and the variation of fluorescence strength (F). Apparently, the relationship shown in FIG. 9 is linear.

Then, a target radiation is applied to the sheet (i.e., dosimeter) and the fluorescence strengths are measured in the same manner, to obtain the variation of the fluorescence strength (F). The obtained F value is applied to the calibration curve (e.g., that of FIG. 9), to determined the radiation dose of the applied X-rays.

As is easily understood from the description set forth above, the above-described procedure can be utilized for producing a two-dimensional radiation image by detecting fluorescences emitting from each pixel which is imaginarily formed on a radiation image storage panel. As to the radiation image storage panel and the procedure for producing a two-dimensional radiation image, the descriptions given hereinbefore as well as a great number of patent publications and other published documents can be utilized.

What is claimed is:

1. A method for measuring a radiation dose which comprises the steps of:
applying a target radiation to a dosimeter containing a terbium-samarium co-activated alkaline earth metal rare earth oxide phosphor which is composed of an oxygen atom and a composition of the formula (I):
M^{II}M^{III}₂:xTb,ySm (I)
in which M^{II} is at least one alkaline earth metal element selected from the group consisting of Mg, Ca, Sr and Ba; M^{III} is at least one rare earth element selected from the group consisting of y, La, Gd and Lu; and x and y are numbers satisfying the conditions of 0<x≦0.1 and 0<y≦0.1, respectively; and
measuring a variation per unit time of strength of a green light emitted by the phosphor.

2. The method of claim 1, wherein the dosimeter is in the form of a sheet which comprises a support and a phosphor layer containing the phosphor.

3. The method of claim 1, wherein M^{II} in the formula (I) is at least one of Sr and Ba, and M^{III} in the formula (I) is at least one of Y and Gd.

4. The method of claim 1, which further comprises the step of preparing a calibration curve by applying a standard target radiation in a known dose to the same dosimeter, and measuring a variation per unit time of strength of a green light emitted by the phosphor.

5. A method of producing a radiation image which. comprises the steps of:
applying a radiation having passed through a target or having been radiated by a target onto a radiation image storage panel containing a layer of terbium-samarium co-activated alkaline earth metal rare earth oxide phosphor which is composed of an oxygen atom and a composition of the formula (I):
M^{II}M^{III}₂:xTb,ySm (I)
in which M^{II} is at least one alkaline earth metal element selected from the group consisting of Mg, Ca, Sr and Ba; M^{III} is at least one rare earth element selected from the group consisting of Y, La, Gd and Lu; and x and y are numbers satisfying the conditions of 0<x≦0.1 and 0<y≦0.1, respectively;
determining a variation per unit time of strength of a green light emitted by the phosphor in each pixel which is imaginarily set on the storage panel, to obtain two-dimensional image data for each pixel; and
producing a radiation image from the obtained image data.

6. The method of claim 5, wherein M^{II} in the formula (I) is at least one of Sr and Ba, and M^{III} in the formula (I) is at least one of Y and Gd.

7. A method for measuring a dose of ultraviolet rays which comprises the steps of:
applying a target radiation to a means containing a terbium-samarium co-activated alkaline earth metal rare earth oxide phosphor which is composed of an oxen atom and a composition of the formula (I):
M^{II}M^{III}₂:xTb,ySm (I)
in which M^{II} is at least one alkaline earth metal element selected from the group consisting of Mg, Ca, Sr and Ba; M^{III} is at least one rare earth element selected from the group consisting of Y, La, Gd and Lu; and x and y are numbers satisfying the conditions of 0<x<0.1 and 0<y<0.1, respectively; and
measuring a variation per unit time of strength of a green light emitted by the phosphor.

8. The method of claim 7, wherein the means is in the form of a sheet which comprises a support and a phosphor layer containing the phosphor.

9. The method of claim 7, wherein M^{II} in the formula (I) is at least one of Sr and Ba, and M^{III} in the formula (I) is at least one of Y and Gd.

10. The method of claim 7, which further comprises the step of preparing a calibration curve by applying standard target ultraviolet rays in a known dose to the same means, and measuring a variation per unit time of strength of a green light emitted by the phosphor.

11. A method for measuring a radiation dose which comprises the steps of:
applying ultraviolet rays to a dosimeter containing a terbium-samarium co-activated alkaline earth metal rare earth oxide phosphor which is composed of an oxen atom and a composition of the formula (I):
M^{II}M^{III}₂:xTb,ySm (I)
in which M^{II} is at least one alkaline earth metal element selected from the group consisting of Mg, Ca, Sr andr Ba; M^{III} is at least one rare earth element selected from the group consisting of Y, La, Gd and Lu; and x and y are numbers satisfying the conditions of 0<x≦0.1 and 0<y≦0.1, respectively;
measuring a strength of a green light and a strength of a red light emitted by the phosphor to which the ultraviolet rays have been applied;
applying a target radiation to the dosimeter, so as to cause variation of atomic valency for the terbium and samarium;
applying ultraviolet rays to the dosimeter to which the target radiation has been applied;
measuring a strength of green light and a strength of a red light emitted by the phosphor to which the ultraviolet rays have been applied after application of the target radiation; and
comparing the former strengths of the green light and red light with the latter strengths of the green light and red light.

12. The method of claim 11, wherein the dosimeter is in the form of a sheet which comprises a support and a phosphor layer containing the phosphor.

13. The method of claim 11, wherein M^{II} in the formula (I) is at least one of Sr and Ba, and M^{III} in the formula (I) is at least one of Y and Gd.

14. A method of producing a radiation image which comprises the steps of:
applying ultraviolet rays to a radiation image storage panel containing a layer of a terbium-samarium co-activated alkaline earth metal rare earth oxide phosphor which is composed of an oxygen atom and a composition of the formula (I):
M^{II}M^{III}₂:xTb,ySm
in which M^{II} is at least one alkaline earth metal element selected from the group consisting of Mg, Ca, Sr and Ba; M^{III} is at least one rare earth element selected from the group consisting of Y, La, Gd and Lu; and x and y are numbers satisfying the conditions of 0<x≦0.1 and 0<y≦0.1, respectively;
measuring in each pixel which is imaginarily set on the storage panel, a strength of a green light and a strength of a red light emitted by the phosphor to which the ultraviolet rays have been applied, to obtain two-dimensional image data for each pixel;
applying a radiation having passed through a target or having been radiated by a target onto a radiation image storage panel, so as to cause variation of atomic valency for the terbium and samarium in each pixel;
applying ultraviolet rays to the storage panel to which the target radiation has been applied;
determining in each pixel a strength of green light and a strength of a red light emitted by the phosphor to which the ultraviolet rays have been applied after application of the target radiation, to obtain two-dimensional image data for each pixel; and
processing the latter strengths of the green light and red light with reference to the former strengths of the green light and red light in each pixel, for producing a radiation image from the obtained image data.
